(19) United States
(12) Patent Application Publication
(10) Pub. No.: US 2006/0259521 A1
(43) Pub. Date: Nov. 16, 2006

(54) Interface for synchronization of documents between a host computer and a portable device

(76) Inventors: Anthony Armenta, San Jose, CA (US); Gurmeet S. Kalra, Newark, CA (US); Edgar Y. Lee, Palo Alto, CA (US); Stephane R. Maes, Mountain View, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/130,593

(22) Filed: May 16, 2005

(51) Int. Cl. G06F 17/30

(52) U.S. Cl. 707/201

(57) ABSTRACT

A folder or file on the first computing device to be synchronized with a second, portable computing device is selected by a first icon corresponding to the folder or file being dragged and dropped to overlap with a second icon corresponding to data management software running on the first computing device. Both the first icon and the second icon are displayed on the user interface provided by the data management software. A folder or file on the second computing device to be synchronized with the first computing device is located at a predetermined location in the second computing device for synchronization with the first computing device. The selected folder or file is partitioned into a plurality of segments. The synchronization of the selected folder or file is performed in terms of these segments while maintaining a count of the number of segments that were synchronized.

### BACKGROUND OF THE INVENTION

1. Field of the Invention

The present invention relates to synchronization of documents between a host computing device and a portable computing device, and more specifically, to a convenient user interface for identifying documents to be synchronized between the host computing device and the portable computing device.

2. Description of the Related Art

Conventional portable computing devices such as personal digital assistants (PDAs) or other types of handheld computing devices are designed to operate in conjunction with a host computing device such as a desktop computer or laptop computer. The host computing devices typically include data management software that provides a user interface for managing the data stored on the portable computing device. Such data management software can also cause the documents stored on the host computing device to be synchronized with the portable computing device and the documents stored on the portable computing device to be synchronized with the host computing device, so that both the host computing device and the portable computing device have the same copy of the most updated version of the documents.

Conventional data management software for managing the data stored on the portable computing device typically provide a user interface, such as a command icon, for a user to indicate to the data management software that all or certain folders/files should be synchronized between the host computing device and the portable computing device. However, users of the conventional data management software have to go through several steps to identify folders, files, or documents to be synchronized. In other words, conventional data management software is not able to provide a convenient user interface to identify folders, files, or documents to be synchronized between the host computing device and the potable computing device.

In addition, conventional data management software performs synchronization of data between the host computing device and the portable computing device in terms of the entire document, and thus is not able to manage the synchronization of data effectively if the portable computing device is disconnected from the host computing device in the middle of the synchronization. That is, when the portable computing device is reconnected to the host computing device after the disconnection, conventional data management software performs the synchronization all over again starting from the beginning of the document.

Therefore, there is a need for data management software with a convenient user interface in which folders, files, or documents to be synchronized between the host computing device and the portable computing device may be easily identified. There is also a need for a method and system for synchronization of a document between the host computing device and the portable computing device where, if the portable computing device is disconnected from the host computing device and later reconnected, the synchronization does not have to be performed on the entire document all over starting from the beginning of the document.

### SUMMARY OF THE INVENTION

Embodiments of the present invention include data management software for managing the synchronization of documents between a first computing device and a second, portable computing device using a convenient user interface for identifying and receiving a selection of the document to be synchronized. The data management software runs on the first computing device.

In one embodiment, a folder or file on the first computing device to be synchronized with the second computing device is selected by a first icon corresponding to the folder or file being dragged and dropped to overlap with a second icon corresponding to the data management software on the user interface. Both the first icon and the second icon are displayed on the user interface provided by the data management software on the first computing device. Therefore, the data management software in accordance with the present invention provides a very convenient user interface for indicating which folders or files should be synchronized, in terms of a simple drag and drop of an icon. The selected folder or file is synchronized between the first computing device and the second computing device.

In another embodiment, a folder or file on the second computing device to be synchronized with the first computing device is located on a predetermined location in the second computing device for synchronization with the first computing device. In other words, that the folder or file is located at the predetermined location in the second computing device indicates that such folder or file on the second computing device is one that can be synchronized with the first computing device.

In still another embodiment of the present invention, the selected folders or files are synchronized in terms of segments. In this regard, the data in each of the selected file are partitioned into a plurality of segments, and the synchronization of the selected folder or file is performed by synchronizing in terms of these segments while maintaining a count of the number of segments that were synchronized. If there are multiple files in a selected folder, each of the multiple files is segmented. One segment contains data only from one file rather than multiple files. If the second computing device is disconnected from the first computing device, the data management software determines the current count indicative of the number of segments that were synchronized prior to the second computing device being disconnected. Therefore, if the second computing device is reconnected to the first computing device, the synchronization of the file can restart where the previous synchronization left off, i.e., from the next segment corresponding to the next count subsequent to the current count of the number of segments that were synchronized prior to the second computing device being disconnected from the first computing device. As a result, the data management software does not have to perform the entire synchronization all over when the second computing device is disconnected from the first computing device in the middle of the synchronization process, but can perform synchronization of only the remaining segments that were not previously synchronized prior to the disconnection of the second computing device.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1A illustrates an embodiment of a handheld computing device used with a host computing device in accordance with the present invention.

FIG. 1B is a block diagram illustrating an embodiment of a hardware architecture of the host computing device in accordance with the present invention.

FIGS. 1C, 1D, and 1E illustrate one embodiment of a portable (or handheld) computing device in accordance with the present invention.

FIG. 2 is a flowchart illustrating one embodiment of a method of synchronizing folders or files between the host computing device and the portable computing device, in accordance with the present invention.

FIG. 3 is a flowchart further illustrating one embodiment of the synchronization step 208 of FIG. 2, in accordance with the present invention.

FIGS. 4A-4C illustrate one embodiment of a user interface provided by the data management software running on the host computing device for identifying a folder/file on the host computing device to be synchronized with the portable computing device, in accordance with the present invention.

FIGS. 5A-5D illustrate one embodiment of a user interface provided by the data management software running on the host computing device for identifying a folder/file on the portable computing device to be synchronized with the host computing device, in accordance with the present invention.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the FIGS. and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

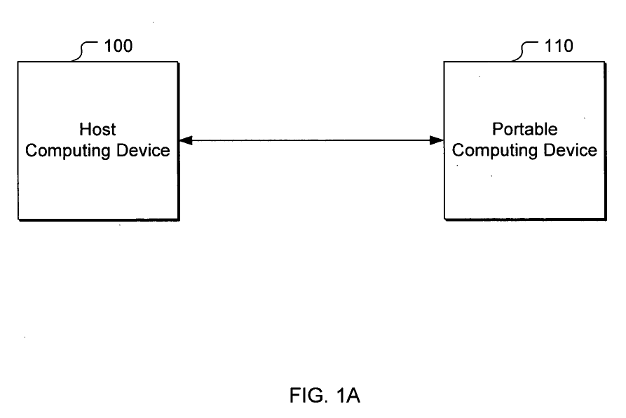

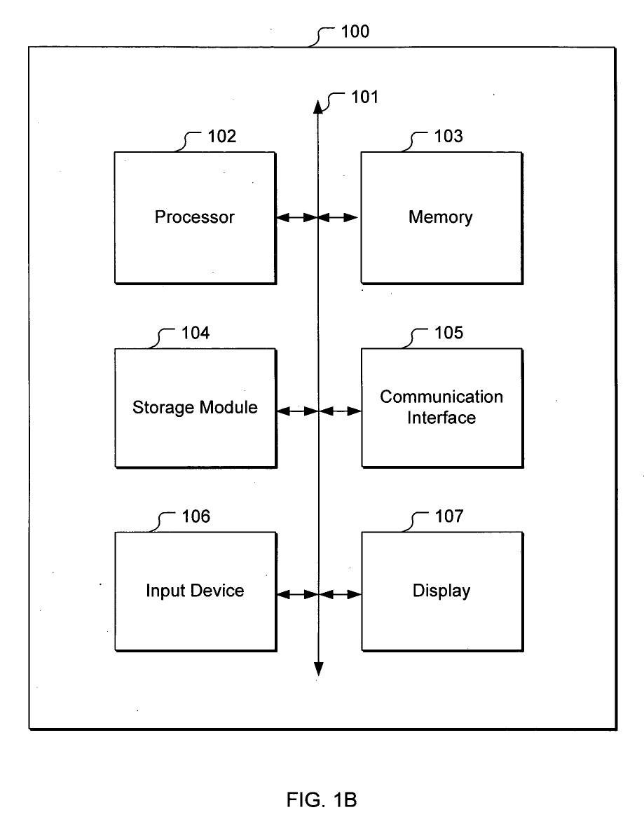

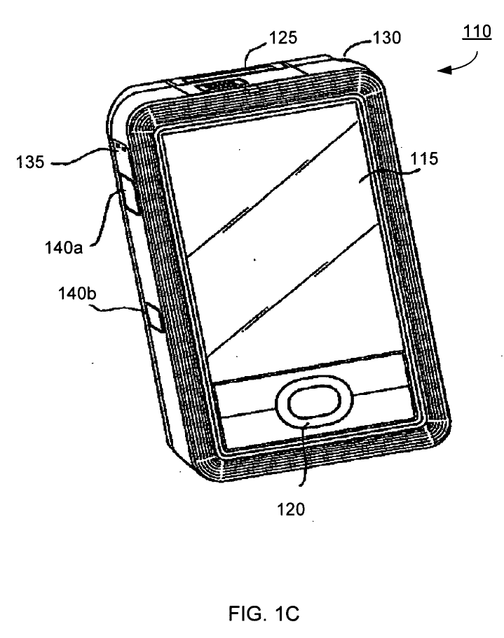

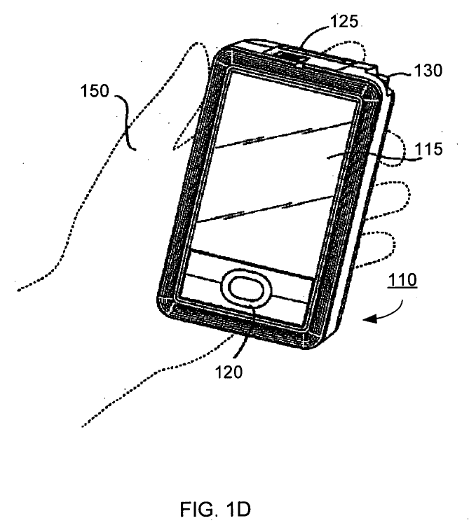

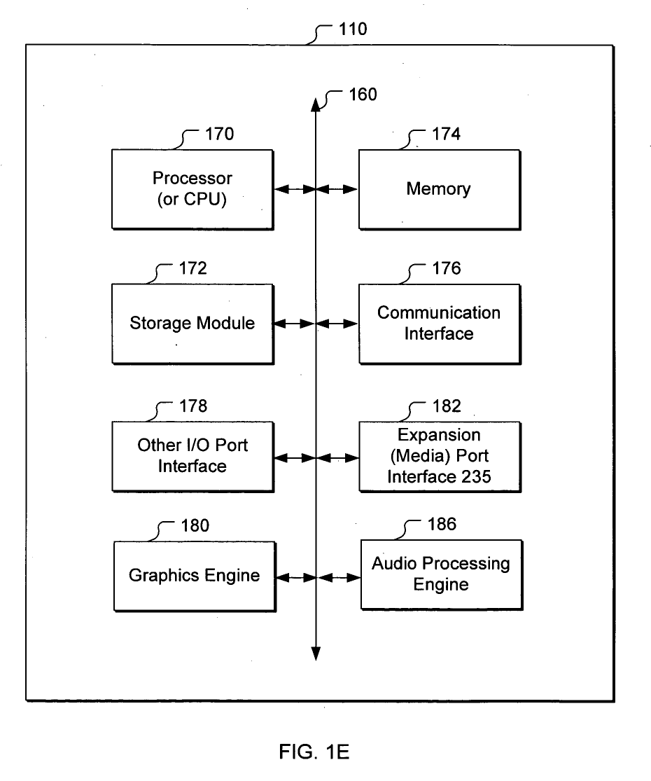

FIG. 1A is a simplified diagram illustrating a portable (or handheld) computing device 110 used with a host computing device 100. The host computing device may be a conventional personal computer such as a desktop computer or a laptop computer or any other type of computing device. The portable computing device 110 may be a personal digital assistant (PDA), a cellular telephone, a smart phone, a media player device, or even another personal computer such as a laptop computer.

The portable computing device 110 is capable of communicating with the host computing device 100 to exchange data between each other. For example, a user may work on a document on the host computing device 100, and then transfer the document to the portable computing device 110 so that he can carry the document in the portable computing device 110 and work on it while he is traveling. After that, the user may want to transfer the updated document on the portable computing device 100 back to the host computing device 100.

In this regard, the host computing device 100 includes data management software for managing the exchange and synchronization of data between the host computing device 100 and the portable computing device 110. The synchronization of data is performed for allowing both the host computing device 100 and the portable computing device 110 to have the most updated/recent version of the documents (folders/files). Synchronization may occur in response to a command by the user (e.g., pressing a button or making a menu selection), automatically at a predetermined timing tracked by a timer application, or any time when the portable computing device 110 is connected to the host computing device, and the like.

FIG. 1B is a block diagram illustrating the hardware architecture of the host computing device, according to one embodiment of the present invention. In one embodiment, the host computing device 100 is a general purpose personal computer including a processor 102, a memory 103, a storage module (e.g., hard disk drive) 104, an input device (keyboard, mouse, and the like) 106, a display 107, and a communication interface 105, all exchanging data with one another through a data bus 101. The communication interface 105 may include one or more interfaces used to communicate with the portable computing device 110 and exchange and synchronize data between each other. The communication interface 105 may be a USB (Universal Serial Bus) interface, a serial interface, a parallel interface, a Bluetooth interface, a WiFi (IEEE 802.11) interface, a cellular telephone interface, or any other type of wired or wireless communication interface. The storage module 104 stores the data management software that is run by the processor 102 in conjunction with the memory 103 to manage the synchronization and exchange of data between the host computing device 100 and the handheld computing device 110.

FIGS. 1C, 1D, and 1E illustrate one embodiment of a portable computing device in accordance with the present invention. As illustrated in FIG. 1D, the portable computing device 110 is configured to be of a form factor that is convenient to hold in a user's hand, for example, a personal digital assistant (PDA) or a smart phone form factor. For example, the portable computing device 110 can have dimensions that range from 3 to 6 inches by 2 to 5 inches by 0.25 to 0.85 inches, and weigh between 2 and 10 ounces.

Referring back to FIG. 1C, the portable computing device 110 includes a screen (or display) 115, a screen navigation interface 120, an expansion port (or slot) 125, a stylus 130, a microphone 135, and one or more control buttons, e.g., voice recorder button, screen rotation button, etc., 140a, b (generally 140). The screen is, for example, a 320×480 transflective TFT color display that includes touch screen support. The expansion (or media) slot 125 is configured to receive and support various expansion (or media) cards that include memory such as CompactFlash™ cards, SD (Secure Digital) cards, xD cards, Memory Sticks™, MultiMediaCard™, SDIO cards, and the like. Further, the screen navigation interface 120, the stylus 130, the microphone 135, and the one or more control buttons 140 are conventional, although various functions can be applied to them.

Turning to FIG. 1E, illustrated is one embodiment of a computing architecture of the portable computing device 110 in accordance with the present invention. The portable computing device 110 includes a processor (or CPU) 170, a storage module 172, a memory 174, a communication interface 176, an expansion (or media) port interface 182, one or more other input/output (I/O) port interfaces 178, an optional graphics engine 180, and an audio processing engine 186. Each of the components of the portable computing device 110 may communicatively couple through a data bus 160.

The processor 170 is a conventional processor or controller such as an Intel® XScale™ processor. The storage module 172 is a conventional long term storage device, for example, a hard drive (e.g., magnetic hard drive) or a flash memory drive. The memory 174 is a conventional computing memory such as a random access memory (RAM). The expansion (media) port interface 182 is configured to interface with an expansion (or media) card such as the ones previously described. The optional graphics engine 180 may include hardware, e.g., graphics chip, in addition to software to enhance graphics for display on the display screen 115.

The audio processing engine 186 is configured for audio related processing such as recording and playback, and includes appropriate hardware (e.g., microphone, speaker, and/or ports (or jacks) for such connections) and software (e.g., sound controls, channel control, and the like). The communication interface 176 is configured for network connections to a wide range of networks and includes appropriate hardware and software to communicatively couple to such networks. Examples of networks that can be configured to function with the handheld computing device 110 include personal area networks (e.g., Bluetooth), wireless networks (e.g., IEEE 802.11), and telecommunications networks (e.g., cellular or data). The one or more other I/O ports 178 include interfaces for connections such as universal serial bus (USB), IEEE 1394 (e.g., FireWire), and the like.

In addition, it is noted that the portable computing device 110 is configured to use conventional operating systems such as Palm OS® from PalmSource™, Inc. or Windows CE or Windows Mobile from Microsoft® Corporation. It is noted that the device can also be configured for use with other operating systems, for example, Linux-based operating systems.

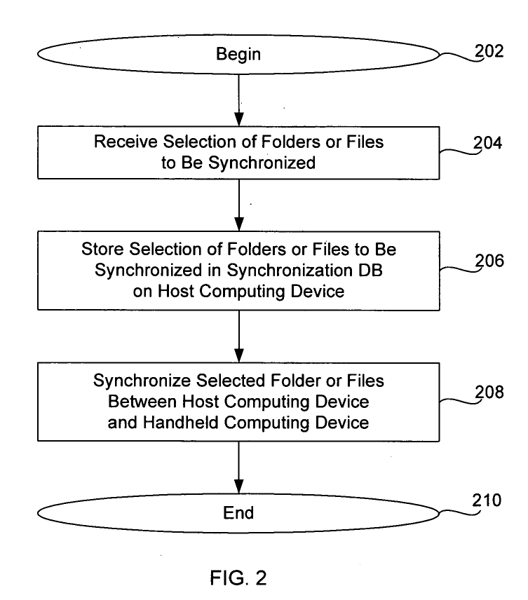

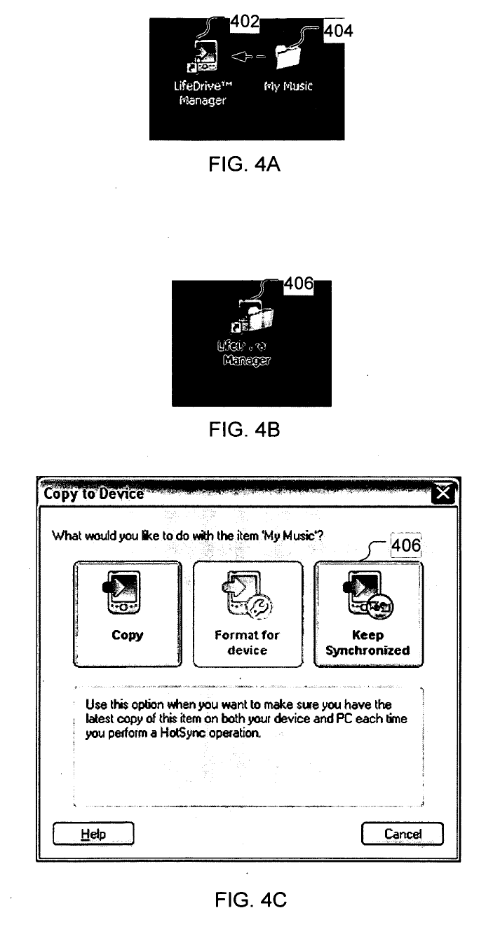

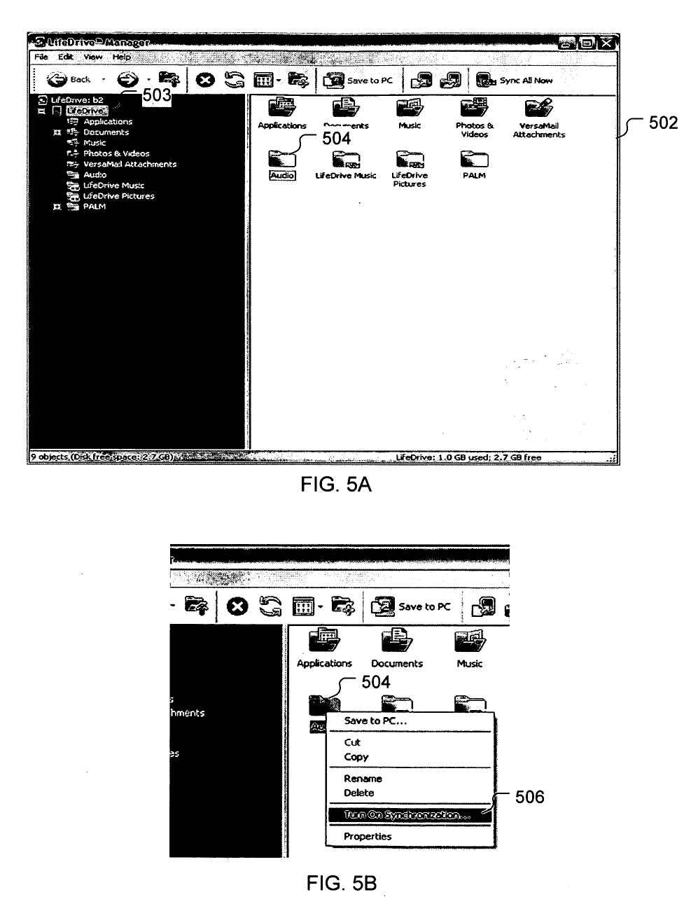

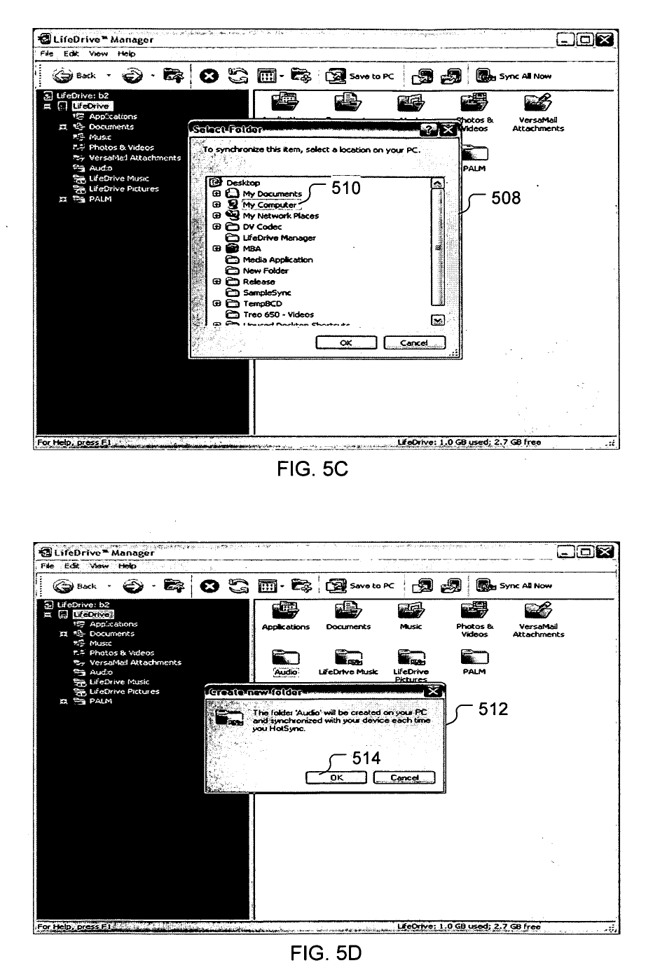

FIG. 2 is a flowchart illustrating a method of synchronizing folders or files between the host computing device 100 and the portable computing device 110, according to one embodiment of the present invention. As the process begins 202, the data management software receives 204 a selection of the folders or files to be synchronized between the host computing device 100 and the portable computing device 110. Such selection of folders or files is received through a convenient user interface provided by the data management software running on the host computing device 100, as will be explained further with reference to FIGS. 4A-4C and 5A-5C. The selection of the folders or files to be synchronized is stored 206 in a synchronization data database (DB) of the data management software.

The data management software causes the selected folders or files to be synchronized 208 between the host computing device 100 and the portable computing device 110 by state of the art synchronization algorithms, and the process ends 210. Note that the synchronization of the selected folder or file can continue even if the name of the folder or file changes, because the data management software tracks the change of the name of the folder or files.

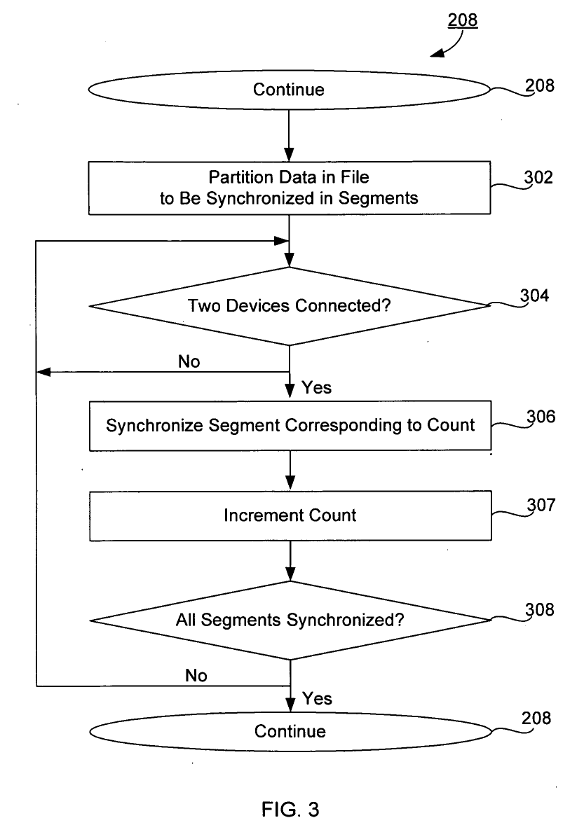

FIG. 3 is a flowchart further illustrating the synchronization step 208 of FIG. 2 in further detail, according to one embodiment of the present invention. For the synchronization 208, the data of the files to be synchronized are partitioned 302 into a plurality of segments. For example, the files may be partitioned into 8 KByte segments. In this regard, the data in each of the selected file are partitioned into a plurality of segments, and the synchronization of the selected file is performed by synchronizing in terms of these segments while maintaining a count of the number of segments that were synchronized. If there are multiple files in a selected folder, each of the multiple files is segmented. One segment contains data only from one file rather than multiple files. Then, the data management software determines 304 whether the host computing device 100 and the portable computing device 110 are communicatively connected to each other for communication. If the two devices are not communicatively connected, the data management software continues the step 304 until they become communicatively connected.

The data management software maintains a count of the number of segments that were synchronized. The count can be maintained using a counter type mechanism. Thus, the data management software synchronizes 306 the segments of the file, and then increments 307 the count for each segment that is synchronized. The data management software determines 308 whether all segments of the file were synchronized by comparing the current count with the number of segments, and repeats steps 304-308 if all segments were not synchronized.

Even if the portable computing device 110 is disconnected 304 from the host computing device 100 in the middle of the synchronization process, the synchronization method of the present invention has the advantage that the synchronization of the folder/file need not restart from the beginning all over, but can restart from the segment of a file subsequent to the segments previously synchronized prior to the disconnection. Thus, the synchronization may continue from the segment of the file corresponding to the next count subsequent to the current count in steps 306-307. This is possible because the data management software synchronizes data between the host computing device 100 and the portable computing device 110 in terms of segments and maintains a count of the number of segments previously synchronized.

FIGS. 4A-4C illustrate a user interface provided by the data management software running on the host computing device 100 to identify a folder/file on the host computing device 100 to be synchronized with the portable computing device 110. In FIG. 4A, the data management software (illustrated in the figure as “LifeDrive Manager™”) itself is indicated as an icon 402 in a window or background displayed by the operating system of the host computing device 100. Other icons corresponding to other folders or files, such as the “My Music” folder 404, can also be shown on a window or background displayed by the operating system of the host computing device 100.

In FIG. 4B, in order to indicate to the data management software that the “My Music” folder (including all files in the “My Music” folder) on the host computing device 100 should be synchronized with the portable computing device 110, the user interface of the data management software allows the user to drag the icon 404 corresponding to the folder/file to be synchronized (e.g., the “My Music” folder) to overlap 406 with the icon 402 corresponding to data management software for the portable computing device 110 running on the host computing device 100. In response, the data management software recognizes that this as an indication that the “My Music” folder on the host computing device 100 should be synchronized with portable computing device 110, by confirming (“keep synchronized?”) 406 with the user, as shown in FIG. 4C. The selected “My Music” folder 404 is synchronized with the portable computing device 110, upon the user's confirmation 406. Therefore, the data management system in accordance with the present invention provides a very simple and convenient user interface for identifying a folder/file on the host computing device 100 to be synchronized with the portable computing device 110 in terms of a simple drag and drop of an icon displayed on the user interface of the host computing device 110.

FIGS. 5A-5D illustrate a user interface provided by the data management software running on the host computing device 100 to identify a folder/file on the portable computing device 110 to be synchronized with the host computing device 100. In FIG. 5A, the data management software (illustrated in the figure as “LifeDrive Manager™”) itself is shown as displaying a window 502 on the host computing device 100. The folder “LifeDrive” 503 representing the portable computing device 110 is shown as a folder in the “LifeDrive Manager™” window 502. In addition, a folder (“Audio”) 504 on the portable computing device 110 is also shown when the root folder “LifeDrive” 503 on the portable computing device 110 is clicked.

In FIG. 5B, in order to indicate to the data management software (“LifeDrive Manager”) that the “Audio” folder (including all files in the folder) 504 on the portable computing device 110 should be synchronized with the host computing device 100, the user interface provided by the data management software (“LifeDrive Manager™”) allows the user to right click with a mouse with the pointer of the mouse on the “Audio” folder 504 to display a menu. Note that only a folder or file located at the “LifeDrive” 503 directory (root directory of the second computing device 1110) can be selected for synchronization with the first computing device 100, according to one embodiment of the present invention, although in other embodiments other locations can be designated for including folders or files for synchronization with the first computing device 100.

The user can select 506 the “Turn On Synchronization” command to identify that the “Audio” folder 504 on the portable computing device 110 should be synchronized with the host computing device 100. In response, the data management software displays another window 508 for the user to select the location on the host computing device 100 at which the “Audio” folder 504 should be stored for synchronization. Here, the user selects the “My Computer” folder 510 on the host computing device 100 as the location to store the “Audio” folder 504 of the portable computing device for synchronization with the host computing device 100. The data management software asks the user for confirmation of this command by displaying the window 512 indicating that the “Audio” folder 504 will be created on the host computing system 100 and synchronized with the portable computing device, which is confirmed by the user's clicking “OK” 514.

It is noted that in one embodiment, the processes described herein are configured for operation as software or a computer program product. The software can be stored as instructions in a memory 103 or a storage module (or device) 104 and is executable. The instructions (e.g., steps) of the process may also be configured as one or more modules that are configured to perform the function or functions described herein.

It is also noted that although the disclosure herein makes references in some embodiments to interaction between a personal computer and portable computing device, the principles disclosed herein are applicable to any configuration in which two computing devices are communicatively coupled. For example, in some embodiments there may be communications between a first computing device and a second computing device wherein the first device can be any computing type device (e.g., a server computer system, a personal computer, a desktop computer, a laptop computer, a personal digital assistant, a gaming device, a smart phone, etc.) or a portable computing system) and the second device can be any computing device (e.g., also a server computer system, a personal computer, a desktop computer, a laptop computer, a personal digital assistant, a gaming device, a smart phone, etc), of which one device may be a host and the other a client or the devices may be peers (e.g., peer to peer connection).

Upon reading this disclosure, those of ordinary skill in the art will appreciate still additional alternative structural and functional designs for a system and a process for synchronization documents between the host computing device and the portable computing device through the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A computer-implemented method of synchronizing a document between a first computing device and a second computing device, the method comprising:
receiving a selection of the document stored on the first computing device to be synchronized with the second computing device, the selection being indicated by a first icon corresponding to the document being dragged and dropped to overlap with a second icon corresponding to an application for managing synchronization of the documents between the first computing device and the second computing device, the application running on the first computing device and both the first icon and the second icon displayed on a user interface provided by the application on the first computing device; and
synchronizing the selected document between the first computing device and the second computing device.

2. The computer-implemented method of claim 1, wherein receiving a selection comprises receiving a selection of a folder including a plurality of files, the first icon corresponding to the folder, and synchronizing the selected document comprises synchronizing the plurality of files between the first computing device and the second computing device.

3. The computer-implemented method of claim 1, further comprising receiving a selection of another document on the second computing device to be synchronized with the first computing device, said another document being stored on a predetermined location in the second computing device for synchronization with the first computing device.

4. The computer-implemented method of claim 1, wherein the selected document is synchronized in response to the second computing device being connected to the first computing device.

5. The computer-implemented method of claim 1, wherein the selected document is synchronized in response to a timer reaching a predetermined time.

6. The computer-implemented method of claim 1, wherein synchronizing the selected document comprises:
partitioning the document into a plurality of segments;
synchronizing the document between the first computing device and the second computing device by the segments; and
maintaining a count of number of segments that were synchronized.

7. The computer-implemented method of claim 6, wherein synchronizing the selected document further comprises:
responsive to the second computing device being disconnected from the first computing device, determining a current count of the number of segments that were synchronized prior to the second computing device being disconnected; and
responsive to the second computing device being reconnected to the first computing device, restarting synchronization of the document from a next segment corresponding to a next count subsequent to the current count.

8. A computer readable medium storing a computer program product including an application configured to cause a first computing device to perform a computer-implemented method of synchronizing a document between the first computing device and a second computing device, the method comprising:
receiving a selection of the document stored on the first computing device to be synchronized with the second computing device, the selection being indicated by a first icon corresponding to the document being dragged and dropped to overlap with a second icon corresponding to the application, the application for running on the first computing device, and both the first icon and the second icon displayed on a user interface provided by the application on the first computing device; and
synchronizing the selected document between the first computing device and the second computing device.

9. The computer readable medium of claim 8, wherein receiving a selection comprises receiving a selection of a folder including a plurality of files, the first icon corresponding to the folder, and synchronizing the selected document comprises synchronizing the plurality of files between the first computing device and the second computing device.

10. The computer readable medium of claim 8, wherein the method further comprises receiving a selection of another document stored on the second computing device to be synchronized with the first computing device, said another document being stored on a predetermined location in the second computing device for synchronization with the first computing device.

11. The computer readable medium of claim 8, wherein the selected document is synchronized in response to the second computing device being connected to the first computing device.

12. The computer readable medium of claim 8, wherein the selected document is synchronized in response to a timer reaching a predetermined time.

13. The computer readable medium of claim 8, wherein synchronizing the selected document comprises:
partitioning the document into a plurality of segments;
synchronizing the document between the first computing device and the second computing device by the segments; and
maintaining a count of number of segments that were synchronized.

14. The computer readable medium of claim 13, wherein synchronizing the selected document further comprises:
responsive to the second computing device being disconnected from the first computing device, determining a current count of the number of segments that were synchronized prior to the second computing device being disconnected; and
responsive to the second computing device being reconnected to the first computing device, restarting synchronization of the document from a next segment corresponding to a next count subsequent to the current count.

15. A first computing device for synchronizing a document with a second computing device, the first computing device comprising:
a storage module for storing a computer program product including an application configured to cause the first computing device to perform a computer-implemented method of synchronizing a document between the first computing device and the second computing device, the computer-implemented method comprising:
receiving a selection of the document stored on the first computing device to be synchronized with the second computing device, the selection being indicated by a first icon corresponding to the document being dragged and dropped to overlap with a second icon corresponding to the application, both the first icon and the second icon displayed on a user interface provided by the application running on the first computing device; and
synchronizing the selected document between the first computing device and the second computing device; and
a processor for executing the computer program product.

16. The first computing device of claim 15, wherein receiving a selection comprises receiving a selection of a folder including a plurality of files, the first icon corresponding to the folder, and synchronizing the selected document comprises synchronizing the plurality of files between the first computing device and the second computing device.

17. The first computing device of claim 15, wherein the method further comprises receiving a selection of another document stored on the second computing device to be synchronized with the first computing device, said another document being stored on a predetermined location in the second computing device for synchronization with the first computing device.

18. The first computing device of claim 15, wherein the selected document is synchronized in response to the second computing device being connected to the first computing device.

19. The first computing device of claim 15, wherein synchronizing the selected document comprises:
partitioning the document into a plurality of segments;
synchronizing the document between the first computing device and the second computing device by the segments; and
maintaining a count of number of segments that were synchronized.

20. The first computing device of claim 19, wherein synchronizing the selected document further comprises:
responsive to the second computing device being disconnected from the first computing device, determining a current count of the number of segments that were synchronized prior to the second computing device being disconnected; and
responsive to the second computing device being reconnected to the first computing device, restarting synchronization of the document from a next segment corresponding to a next count subsequent to the current count.
